(19) United States
(12) Patent Application Publication
(10) Pub. No.: US 2007/0269066 A1
(43) Pub. Date: Nov. 22, 2007

(54) METHOD FOR MANUFACTURING AN AUDIO SIGNAL

(75) Inventors: Ralph Peter Derleth, Hinwil (CH); Adam Hersbach, The Patch (AU)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 11/419,249

(22) Filed: May 19, 2006

(51) Int. Cl. H04R 25/00

(52) U.S. Cl. 381/316

(57) ABSTRACT

To improve processing of audio signals such audio signal is split (7) in two parts, one thereof being processed in time-domain (5) and at least the other part by frequency-domain processing (3). Thereby, the advantages of both processing domains are specifically exploited for respective parts of the signal to be processed.

The present invention has the object to propose an improved method for manufacturing at least one output electric audio signal by processing at least one input electric audio signal.

The present invention departs from recognitions which have been made by the inventors in context with beam-forming at hearing devices, but may be significantly generalized.

### DEFINITIONS

We understand under a hearing device a device which is worn at least adjacent to an individual's one ear with the object to improve individual's acoustical perception. Such improvement may also be barring acoustical signals from being perceived in the sense of hearing protection for the individual. If hearing devices are worn on both individual's ears and are in mutual communication, then we speak of the hearing devices of a binaural hearing system. A hearing device may further be a device to positively improve individual's acoustical perception, whether such individual has an impaired perception or not. If the hearing device is tailored so as to improve the perception of a hearing-impaired individual then we speak of a hearing aid device. With respect to the application area a hearing device may especially be applied behind the ear, completely in the ear canal or may even be implanted.
We understand under beam-forming tailoring the transfer characteristic of an acoustical-to-electrical signal processing arrangement, which transfer characteristic is defined as the ratio of output signal to input signal, and is in fact an amplification characteristic normally addressed in decibel, so that it varies as a function of the direction of arrival of acoustical signals impinging on the sensing surface of the arrangement. Normally such characteristic is represented in polar coordinates and often shows up as a “beam”.

Because the present invention departs from recognitions which have been made in context with beam-forming processes at hearing devices, first the respective considerations at beam-forming processes shall be explained.

Beam-forming is a well-known method e.g. used to increase the signal-to-noise ratio in acoustical environment. The beam-shaped amplification characteristic in polar coordinate representation is realized by combining the sound pressure information, which is retrieved at different loci having a known mutual distance. The sound pressure is thereby sensed at these loci by respective acoustical-to-electrical converters. The skilled artisan perfectly knows e.g. beam-forming following the delay-and-add principal.

Just as examples beam-forming techniques are known e.g. from the U.S. Pat. No. 6,522,756, U.S. Pat. No. 6,603,861, U.S. Pat. No. 6,449,216, U.S. Pat. No. 6,865,275, WO 99/04598, all from the same applicant as the present application. Thereby, it is perfectly known that signal processing is performed either in time-domain, in today's processing art mostly after analog-to-digital conversion, or in frequency-domain which necessitates previous analog-to-digital signal conversion.

As further perfectly known to the skilled artisan, signal processing in time-domain and in frequency-domain mode have, respectively, specific advantages and disadvantages. Such specific advantages and disadvantages shall first be discussed as they are relevant for hearing device beam-forming.

In practice the beam-forming takes place in reverberant acoustical environment and on the head of an individual. Characteristics which limit beam-forming quality achievable are especially level mismatch and phase mismatch at the input acoustical-to-electrical converters. As the phase difference of acoustical signals impinging upon the input converters is the decisive parameter for directivity indication and level mismatch may be considered as due to an amplification setting, both, phase and level mismatch of the input converters leads to deterioration of the achievable beam-forming characteristic. Thus, for optimum beam-forming level mismatch as well as phase mismatch of the input converters has to be compensated best possible. Thereby, the addressed mismatch may be dependent on direction of arrival of the impinging acoustical signals and is frequency-dependent.

Because of the nature of the constantly changing acoustical environment, e.g. with moving acoustical sources, mismatch compensation has to be done on a short time basis and additionally with a reasonably high spectral resolution.

Time-domain signal processing has thereby some disadvantages since no spectral resolution for compensation can be realized.
For low frequencies below 1 kHz phase and level mismatch may accurately be compensated in time-domain. On the other hand processing low-frequency signals in the frequency-domain mode leads to relatively bad beam-forming quality, as no accurate phase matching is possible.
When considering higher frequencies at and above 1 kHz time-domain processing leads to relatively bad beam-forming, as no adaptive frequency-specific level-matching is possible. On the other hand frequency-domain processing leads to good results as adaptive frequency-specific level-matching is possible.

Departing from this recognition the object as addressed above is resolved by the present invention by a method for manufacturing at least one output electric audio signal, by processing at least one input electric audio signal, whereby the input electric audio signal comprises a first part and a second part which is different from the first part. The addressed processing thereby comprises separating the two parts and processing in frequency-domain at least the first part and in time-domain only the second part. Thereby, from the two parts as addressed time-domain processing is only applied to one thereof. Processing in frequency-domain is applied to the second part, but additionally and as will be seen the first part may also be additionally processed in frequency-domain. Latter may be done e.g. just to achieve the same time lag for the second part as is occurring to the first part due to frequency-domain processing.

Thus, and according to the present invention, one part of the signal to be processed is processed in time-domain, the other part in frequency-domain, and the respective selection is made so as to optimally exploit the advantages of the two domain processings for the respective signal parts.

In the EP 1 439 732 according to the US application US 2-005-0175199 entitled “method to operate a hearing device and hearing device” of the same applicant, some advantages and disadvantages of time-domain and frequency-domain processing are discussed. As a consequence there is proposed a hearing device with a main signal processing path and a side signal path. The main signal processing path includes signal processing in frequency-domain mode and thus provides for a relatively large group delay. The side signal path provides no processing, but provides for undelayed time-domain signal transfer. The results of frequency-domain processing in the main signal path and of the unprocessed time-domain signal of the side path are summed leading to a significant reduction of overall time delay for an individual perceiving an acoustical signal. This improves individual's ability to localize acoustic sources in spite of wearing a hearing device.

In a first embodiment of the method of manufacturing according to the present invention the two parts in which the input audio signal is separated, consist of spectrally different components. As was addressed above and in context with beam-forming the two domain processings have respective advantages specifically for different frequency bands of audio signals.

In a further embodiment the addressed separating of the two parts is performed by filtering. Thereby, still in a further embodiment the first signal part which is only processed in frequency-domain consists of higher-frequency components, whereby the second part, which is processed in time-domain, comprises lower-frequency components. The band separation for higher and lower frequencies is applied for audio signals at about 1 kHz so that the addressed higher frequencies are predominantly higher than 1 kHz and the addressed lower frequencies are predominantly lower than 1 kHz.

Still in a further, more specific embodiment of the generic teaching of the present invention, the at least one input electric audio signal is at least dependent from an output signal of an input acoustical-to-electrical converter arrangement of a hearing device.

In another embodiment the input signal to an electrical-to-mechanical converter arrangement of a hearing device is made at least dependent from the addressed output electric audio signal.

Still in a further embodiment the at least one input electric audio signal is at least dependent on an output signal of an input acoustical-to-electrical converter arrangement of a hearing device, and an input signal to an electric-to-mechanical converter arrangement of a further hearing device is made at least dependent from the output electric audio signal and the one and the further hearing devices are selected to be one and the same hearing device. In such a case obviously the addressed method is implied with respect to input and output converters at one hearing device considered.

Still in a further embodiment of the present invention the addressed processing comprises beam-forming.

Still in a further embodiment processing in time-domain and processing in frequency-domain are in fact equal processings, but respectively performed in time and frequency-domain. Thus, e.g. with an eye on beam-forming, both processings are beam-forming processings and e.g. by delay-and-add method, and are applied in time-domain as well as in frequency-domain.

In a further embodiment, wherein processing is beam-forming, the at least one input electric audio signal comprises at least two electrical audio signals respectively dependent on an electric output signal of an acoustical-to-electrical converter.

The invention shall now be described by examples and with the help of figures. They show:

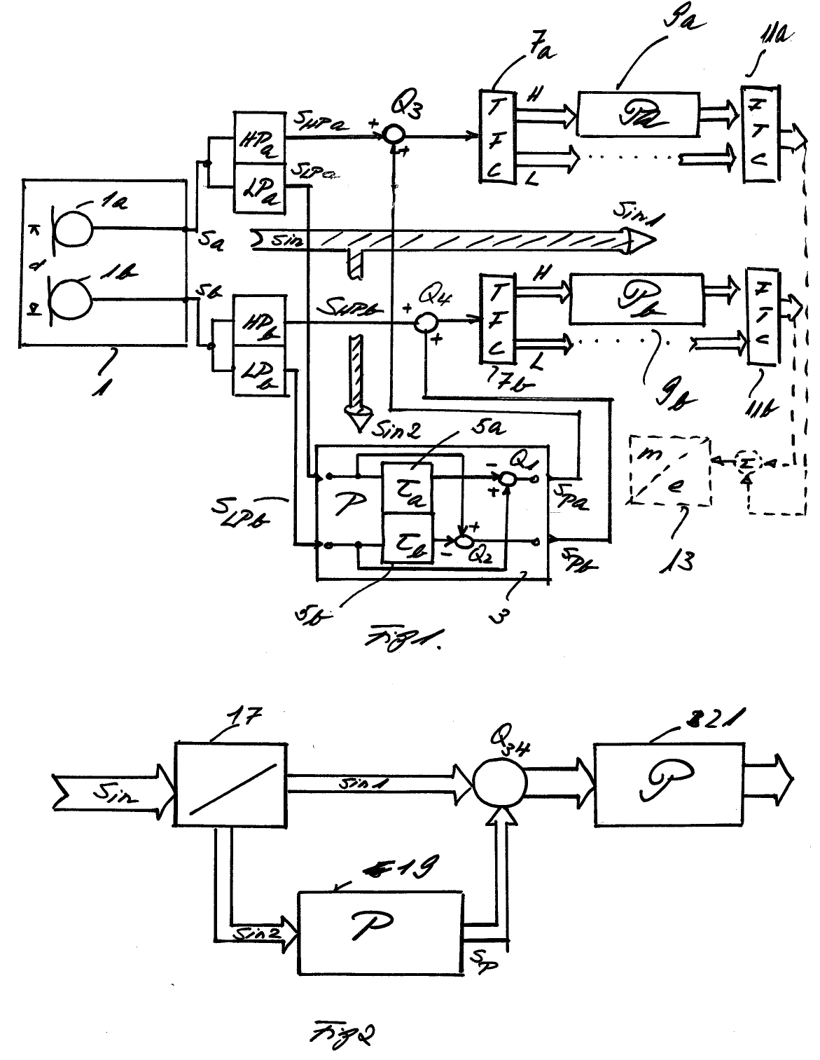

FIG. 1 by means of a simplified signal flow/functional block diagram the method according to the present invention performed for beam-forming processing an input audio signal which is generated by an input acoustical-to-electrical converter arrangement;

FIG. 2 the processing according to FIG. 1 under a more generalized aspect;

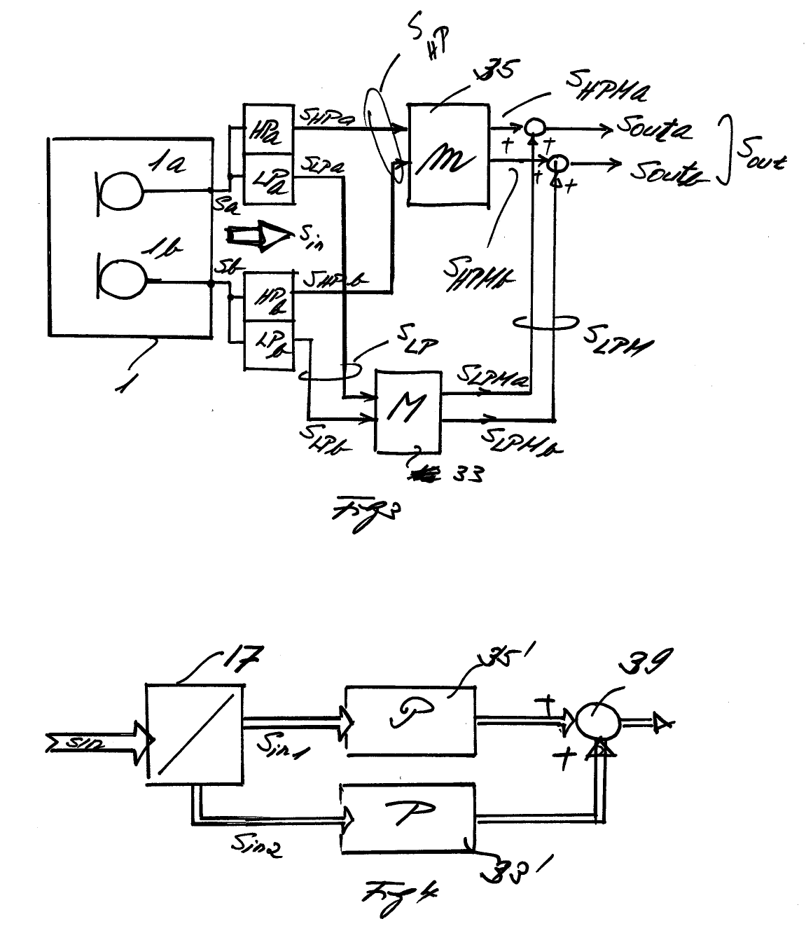

FIG. 3 in a representation in analogy to that of FIG. 1, processing of the output signal of an acoustical-to-electrical converter arrangement in the two domains specifically for mismatch compensation, and

FIG. 4 under a more generalized aspect, the processing as realized by the embodiment of FIG. 3.

In FIG. 1 there is shown by means of a simplified functional block/signal flow diagram a specific embodiment according to the present invention, wherein signal processing is beam-forming at a or for a hearing device. There is provided an input acoustical-to-electrical converter arrangement 1, which, generically, generates an output electric audio signal Sᵢₙ, input signal for subsequent processing. This signal is dependent from acoustical signals impinging on a converter array of the at least two converters 1a and 1b of the arrangement 1.

In the embodiment of FIG. 1 the output audio signal Sᵢₙ of the acoustical-to-electrical converter arrangement 1, consisting of two electric signal Sₐ and S_{b} according to the two specific converters 1a and 1b, is separated into two parts Sᵢₙ₁ and Sᵢₙ₂. Specifically the two parts Sᵢₙ₁ and Sᵢₙ₂ are formed by the higher-frequency components and of the lower-frequency components respectively of both signals Sₐ and S_{b}. Thus, the output signal of converter 1 with the two components Sₐ and S_{b} is separated by respective highpass and lowpass filters HPₐ, HP_{b} and LPₐ, LP_{b}, into the two parts of higher-frequency content and of lower-frequency content. The second part Sᵢₙ₂ of the output signal of converter 1, consisting of the low-frequency components as filtered by the lowpass filters LPₐ and LP_{b}, is fed specifically as the signals S_{LPa} and S_{LPb} to a beam-forming unit 3, wherein, in time-domain processing P, beam-forming is performed upon the signals S_{LPa} and SLP_{b}. As exemplified this is done by means of the delay-and-add technique which is perfectly known to the skilled artisan. By means of allpass filter units 5a and 5b the respective time delays τₐ and τb are introduced. Thus at the summation knots Q₁ and Q₂ respective beams characteristics are realized, e.g. respective forwards and rearwards cardioid beam patterns.

The two beam-characteristic signals which are the result of time-domain beam-forming in unit 3 are output from processing unit 3. The beam-characteristic lower-frequency signal S_{Pb} is summed at Q₄ with the higher-frequent component S_{HPb} from the output signal of converter 1b. In analogy, the lower-frequency time-domain beam-formed signal S_{Pa} is summed at Q₃ with the higher-frequency component S_{HPa}. The summing result of Q₃ and Q₄ are both time-to-frequency converted at unit 7a, 7b. The high-frequency components yet not processed are subsequently processed in frequency-domain beam-processing Pₐ and P_{b}, wherein e.g. the same beam-forming process is performed as in unit 3 but now in frequency-domain. As shown in FIG. 1, because the low-frequency components have already been beam-forming processed in time-domain by unit 3, these low-frequency components are just time-to-frequency converted—L—and reconverted into time-domain as are the outputs of frequency-domain beam-forming Pₐ and P_{b} in units IIa, IIb.

Clearly before establishing reconversion of the frequency-domain beam-forming signals—II—further signal processing in frequency-domain will normally be applied so as to establish a desired signal transfer characteristic between acoustical input to the converter arrangement 1 and a mechanical output from an electrical-to-mechanical output converter 13, to which the resulting electrical output audio signals are operationally connected (dash line). Thus, by means of the embodiment of FIG. 1 there has been shown beam-forming processing of an input audio signal, whereby the input audio signal Sᵢₙ₁ is separated into two parts, namely a higher-frequency and a lower-frequency part. The lower-frequency part only is processed by beam-forming in time-domain. The result signal of such time-domain beam-forming process is summed to the second signal part which consists of higher-frequency components. The summing result is subjected to frequency-domain beam-forming after respective time-to-frequency-domain conversion as is perfectly clear to the skilled artisan.

As may be seen in the specific example of FIG. 1 adding the respective low-frequency components L downstream the summing Q₃ and Q₄ reconstructs the omnidirectional low-frequency characteristics.

By time-domain processing in unit 3 and respective adjustment of the allpass filters phase mismatch compensation is achieved for the lower-frequency part. Also level mismatch of the input converters is compensated in time-domain processing of the lower-frequency part.

Most generically, the approach of combining time-domain and frequency-domain signal processing in fact in parallel on specific parts of a signal allows to selectively apply the optimum domain processing. As of FIG. 1, for the specific beam-forming lower-frequency parts are advantageously time-domain processed and higher-frequency parts are advantageously frequency-domain processed. Such an approach may be of high advantage for signal processing more generically than just for beam-forming.

In FIG. 2 the approach as of FIG. 1 is more generalized.

The electrical audio input signal Sᵢₙ is separated at a unit 17 into two parts Sᵢₙ₁ and Sᵢₙ₂. The second part Sᵢₙ₂ is processed in time-domain P at unit 19 and the result is summed to the first part Sᵢₙ₁ at Q₃₄. Both the unprocessed first part Sᵢₙ₁ and the time-domain processed second part SP are then processed in frequency-domain in unit 21.

Still with an eye on FIG. 1 it must be emphasized that the acoustical-to-mechanical input converter arrangement 1, the output electrical-to-mechanical converter arrangement 13 as well as all the processing as shown may be incorporated within one single hearing device. Nevertheless, the converter arrangement 1 and 13 may also be incorporated in two distinct hearing devices, e.g. of a binaural system. One or both converter arrangements 1, 13 may be provided at a hearing device and processing may be performed remote. Thus, time-domain and frequency-domain processing may be performed in a centralized processing architecture or in a decentralized, possibly with wireless intercommunication of the processes or units. In other words utmost flexibility is possible with respect to the architecture of the embodiment as shown in FIG. 1.

As was discussed above, one of the important considerations to decide which part of an electric audio signal is to be processed in time-domain and which part is to be processed in frequency-domain is matching of the input acoustical-to-electrical converters as of 1a and 1b. If matching is the only topic to be resolved before further signal processing, which further processing may be realized in either of the two domains without specific preference, the signal processing as shown in FIG. 3 may be performed. Here parallel time-domain and frequency-domain processing is performed. According to FIG. 3 the two components Sₐ and S_{b} of Sᵢₙ are again and as was explained in context with FIG. 1 separate in two parts, the lower-frequency part SLP and the higher-frequency part SHP. The former is processed to compensate for low-frequency mismatch of the converters 1a and 1b in time-domain matching unit 33.

There results output signal S_{LPM} with low-frequency-matched S_{LPMa} and S_{LPMb}.

In analogy the higher-frequency part S_{HP} comprising S_{HPa} and S_{HPb} is matched by frequency-domain matching process M in unit 35.

In FIG. 3 time-to-frequency conversion as well as frequency-to-time-domain conversion has been omitted for simpleness.

At the output of unit 35 two matched high-frequency signals are generated. The lower-frequency matched signal S_{LPM} and the higher-frequency matched signal S_{HPM}, after respective conversion and/or reconversion, are summed, resulting in output signals Sₒᵤₜₐ and S_{outb}. The signals S_{OUT} is further processed, be it in time or in frequency-domain to establish the desired transfer characteristic between input acoustical signal Sᵢₙ and output mechanical signal of a hearing device.

In FIG. 4 there is shown, in analogy to FIG. 2, the more generalized processing as of FIG. 3. The electric audio input signal Sᵢₙ is separated in a first part Sᵢₙ₁ and a second part Sᵢₙ₂. The first part is frequency-domain processed as shown by P, whereas the second part is processed in time-domain, P.

The processing results are summed in unit 39. Thus, and according to FIGS. 3 and 4 there is performed parallel time-domain and frequency-domain processing. In FIGS. 3 and 4 both processings are in fact equal but performed in frequency mode for higher frequencies and in time-domain mode for lower frequencies. It is perfectly clear that the principal of the present invention with respect to manufacturing an output electric audio signal, may also be achieved and followed up by applying completely different time-domain and frequency-domain processings if the two signal parts are to be differently treated.

Thus, and as has been shown, by the present invention the advantages of time-domain and frequency-domain processing are specifically exploited in combination.

1. A method for manufacturing at least one output electric audio signal by processing at least one input electric audio signal, said input electric audio signal comprising a first part and a second part different from said first part, said processing comprising separating said parts and processing in frequency-domain at least said first part and in time-domain, only said second part.

2. The method of claim 1, said first part consisting of spectrally different components than said second part.

3. The method of claim 1, said separating comprising filtering.

4. The method of claim 1, said first part consisting of higher-frequency components than said second part.

5. The method one of claim 1, wherein said at least one input electric audio signal is at least dependent from an output signal of an input acoustical-to-electrical converter of a hearing device.

6. The method of claim 1, wherein an input signal to an electrical- to mechanical converter arrangement of a hearing device is made at least dependent from said output electric audio signal.

7. The method of claim 1, wherein said at least one input electric audio signal is at least dependent on an output signal of an input acoustical-to-electrical converter of a hearing device and wherein an input signal to an electrical- to mechanical converter arrangement of a further hearing device is made at least dependent from said output electric audio signal, said one and said further hearing devices being one hearing device.

8. The method of claim 1, said processing comprising beamforming.

9. The method of claim 1, said processing in time-domain and said processing in frequency-domain being the same processing performed in time and in frequency-domain.

10. The method of claim 1, said processing being beamforming and said at least one input electric audio signal comprising at least two electric audio signals respectively dependent from an electric output signal of an acoustical-to-electrical converter each.

11. The method of claim 1, wherein said processing in frequency-domain and said processing in time-domain being performed substantially simultaneously and in parallel.

12. A hearing device system with an input acoustical-to-electrical converter arrangement and with an output electrical-to-mechanical converter, further comprising
said acoustical-to-electrical input converter arrangement being operationally connected to means for separating a signal dependent from an output signal of said acoustical-to-electrical converter arrangement into a first and a second part;
means for time-domain processing only said first part;
means for frequency-domain processing at least the other of said at least two parts;
means for applying an electric signal to the input of said electrical-to-mechanical converter arrangement in dependency of the output of said means for processing in time-domain and said means for processing in frequency-domain.
